(19) United States
(12) Patent Application Publication
(10) Pub. No.: US 2008/0246249 A1
(43) Pub. Date: Oct. 9, 2008

(54) Seat suspension suitable for bicycle use

(76) Inventor: David Frank Pokrywka, Lake Alfred, FL (US)

Correspondence Address: David F. Pokrywka, 215 Old Polk City Rd., Lake Alfred, FL, 33850-8407, US

(21) Appl. No.: 11/732,102

(22) Filed: Apr. 3, 2007

(51) Int. Cl. B62J 1/02; B60J 1/06

(52) U.S. Cl. 280/283; 297/209

(57) ABSTRACT

A bicycle seat suspension suitable for use on other vehicles and equipment which is both lightweight and durable and can be constructed from inexpensive material such as steel or aluminum. The seat suspension consists of a top frame and a bottom frame joined together at the front by a pinned hinge and at the rear by a triple hinge slightly elevated at the top. Suspension is provided by various sprung configurations, one of which is a centrally located spring operated by means of an adjustable push rod, another by means of dual shock absorbing Springs. The actual configuration dependant on frame construction and or rider weight.

### BACKGROUND OF INVENTION

The present invention relates to a vehicle seat suspension system particularly suitable for Use on a bicycle and adaptable to other types of vehicles.

Seat suspension systems have been around probably right after the invention of the wheel Evolving with complex mechanisms on horse drawn wagons then on motorized vehicles.

Many of the designs used on present day bicycles which have springs located in the seat Post tube and travel in a straight up and down motion have somewhat limited travel and because most modern day bicycles seat post down tubes are inclined at an angle at the top towards the rear of the bicycle the shock incurred to the rider tends to be felt sharply Because it is not incurred at a 90 degree angle with respect to the spring.

Other designs used in the past, most notably a hinge mount located at the front or forward of The seat with springs located at the rear of the seat or in the down tube and used on motor cycles, tractors, snow mobiles and many more vehicles are actually somewhat better at shock absorption on a moving vehicle.

I submit for patent consideration a design with a forward hinge with the addition of a Rear triple hinge which greatly adds to the lateral strength of the seat suspension, also with the Addition of adjustable up and down seat movement capability and various springing methods Which Makes for a very functional and versatile seat suspension.

### SUMMARY OF THE INVENTION

In the presented invention of a seat suspension suitable for use on a bicycle or other type of Moving vehicles.

Presented is a seat suspension comprised of a bottom frame, a top frame, a front hinge, a triple rear hinge and various springing arrangements of which configuration is dependant by the Type of vehicle frame constraints, rider weight and or aesthetics. The triple rear hinge of the said seat suspension provides for improved strength especially in the lateral plane which on a bicycle making curving maneuvers is greatly appreciated. The said triple rear hinge can be made of steel or aluminum and is slightly elevated at the top rail with reference to the bottom rail to provide for wheel clearance in the down position as would be incurred upon hitting a large bump. The seat suspension is fully adjustable to accommodate taller riders by adjusting in an up and down fashion just as done on a standard type bicycle by raising or lowering the seat post and clamping in position. Also a forward and rearward positioning can be accomplished by using a standard type bicycle seat which has built in fore and aft adjustment.

The scope of the invention, a fully adjustable seat suspension suitable for use on a bicycle or other type vehicle can be fitted with various types of suspension spring methods one being a centrally located spring shock positioned low and slightly ahead of the rear wheel when fitted on a bicycle, this centrally located spring is clamped at the top of the spring shock to the bicycle frame and at the bottom of the spring shock to the bicycle frame by means of a removable clamp so as to accommodate spring replacement, this spring shock is also fitted with an adjustment at the bottom to accommodate minor spring tension adjustment, major adjustment is accomplished by spring replacement with a stronger spring. As can be viewed in the drawings this said centrally located spring is fitted with an adjustable push rod so as to transfer the rider weight to The spring shock and is adjustable by shortening or lengthening so as to make spring contact and be able to raise or lower the height of the seat suspension frame to accommodate taller riders. The adjustable push rod can be configured singly or in a dual configuration to accommodate differences in various vehicles. The described adjustable push rods upper end is attached to the upper flame of the seat suspension by means of a pin and bushing so as to provide a bearing surface and permit movement when the upper frame member moves downward as would be encountered upon hitting a bump. The lower end of the said push rod is attached to the body of the spring shock by means of a pin and bushing arrangement fitted thru a long slot in the body of the spring shock, this provides connection and to permit movement of the spring in a up and down plane.

In the presented invention of an adjustable seat suspension suitable for use on a bicycle one method of providing suspension was explained, another method of springing is to fit to each side of the upper flame member a standard type shock absorber to which the bottom of the shock absorbers is mounted to the bottom flame member of the seat suspension by means of a bracket as can be seen in the drawings. Still another springing method as shown in the drawings is a Spring contained inside the seat post tube, on a standard bicycle the tube is of small diameter and does not permit the use of a spring of sufficient size to be able to carry sufficient load but could be used to supplement spring load, otherwise the use of a larger seat post tube and spring would be needed to carry the weight of an average person. Another method of springing is to mount a large diameter die spring forward of the seat post and use the method described previously in the centrally located spring shock and with a push rod mounted to the upper frame member by means of a pin and bushing type bearing, and to mount the spring shock body directly to the under side of the lower frame member of the seat suspension and similarly as in the centrally located spring shock, the lower portion of the push rod is attached to the body of the spring shock by means of a pin and bushing arrangement fitted thru a long slot in the body of the shock spring, this spring method is also dependant on mounting clearance of the vehicle frame.

One last spring method must be mentioned and that involves the use of extension type springs this method of providing a means of suspension involves mounting the top of the extension spring to the lower frame member of the seat suspension and with the use of an adjustable push rod attached to the upper frame member of the seat suspension by means of a pin and bushing arrangement, and the lower portion of the push rod attached to the lower portion of the extension type spring but with the addition as viewed in the drawings of a swivel type sliding bearing through which the bottom portion of the push rod slides down and up and is allowed to tilt, this captures and holds the bottom of the extension spring so as to have a predicable movement.

### BRIEF DESCRIPTION OF DRAWINGS

The drawings presented are intended to illustrate, but not limit the invention's potential.

The drawings contain fifteen views.

FIG. 1 is a view of seat suspension fitted on a bicycle in the up position using centrally located spring over hydraulic shock with dual adjustable push rods.

FIG. 2 is a view of seat suspension in the down position as would be encountered upon hitting A bump, using centrally-located spring over hydraulic shock with dual adjustable push rods.

FIG. 3 is a view of seat suspension in the up position using centrally located spring shock with centrally located single Adjustable push rod.

FIG. 4 is a rear view of seat suspension with a central located spring shock and dual adjustable push rods also shown is an optional internally located gas or hydraulic shock.

FIG. 5 is a view of centrally located spring over shock with associated parts

FIG. 6 is a view of seat suspension with front located spring shock in the up position.

FIG. 7 is a view of seat suspension with front located spring shock in the down position.

FIG. 8 is a view of seat suspension with dual rear mounted spring over hydraulic shocks in the up position.

FIG. 9 is a rear view of seat suspension equipped with dual rear mounted spring over hydraulic shocks in the up position.

FIG. 10 is a view of seat suspension fitted with dual rear mounted spring over hydraulic shocks in the down Position

FIG. 11 is a view of seat suspension in the up position fitted with dual extension springs fitted with a single central adjustable push rod and swivel bearing fitting.

FIG. 12 is a view of seat suspension in the down position as would be encountered upon hitting a bump fitted with a single central adjustable push rod and swivel bearing fitting.

FIG. 13 is a rear view of seat-suspension the up position fitted with a single central adjustable push rod and swivel bearing fitting.

FIG. 14 is a view of seat suspension in the up position fitted with a central spring, push rod and plunger in the up position located in the seat post tube.

FIG. 15 is a view of seat suspension in the down position fitted with a central spring, push rod And plunger in the down position located in the seat post tube.

### REFERENCE ITEMS

1, Triple Hinge

2, Central Spring Shock

3, Central Adjustable Length Push Rod

3A, Left Adjustable Length Push Rod

3B, Right Adjustable Length Push Rod

4, Upper Arm Frame

4A, Bicycle Seat Post Tube

4B, Front Split Bushing

4C, Middle Split Bushing

4D, Rear Split Bushing

5, Lower Arm Frame

5A, Bicycle Down Post Tube

6, Seat Suspension Complete

7, Bicycle Frame

7A, Bicycle Seat

8, Front Hinge

8A, Front Hinge Pin

9, Clamp

10, Central Spring Over Shock

10A, Extension Spring

10B, Compression Spring

10C, Compression Spring Inside Down Tube

10D, Spring Over Shock Absorber

11, Central Slotted Spring Shock Tube

11A, Pin For Single Push Rod

11B, Pin For Dual Push Rods

11C, Bushing

11D, Spacer

11E, Clip

11F, Top Collar

11G, Bottom Collar And Spring Adjustment

11H, Pin

11I, Bearing Washer

12, Gas type Shock Absorber

13, Slide Swivel Bushing

14, Front Spring Shock Tube

14A, Front Spring

14B, Front Push Rod

14C, Pin

15, Yoke Type Shock Top

16, Bushing Shock Top

17, Mount for dual shock absorbers

18, Adjustable push rod for extension spring

19, Upper Mounting Pin for extension spring

20, Piston Plunger and Guide Rod

21, Guide Tube

22, Push Rod for Spring inside Down Tube

23, Upper Pin for Push Rod

24. Lower Pin for Push Rod to Piston

25, Spring Land Stop

### DETAILED DESCRIPTION OF THE INVENTION

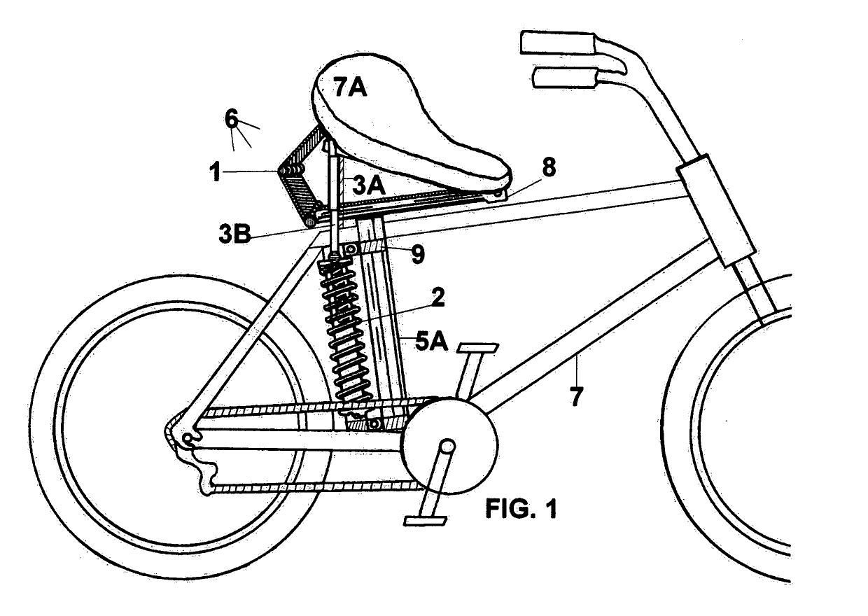

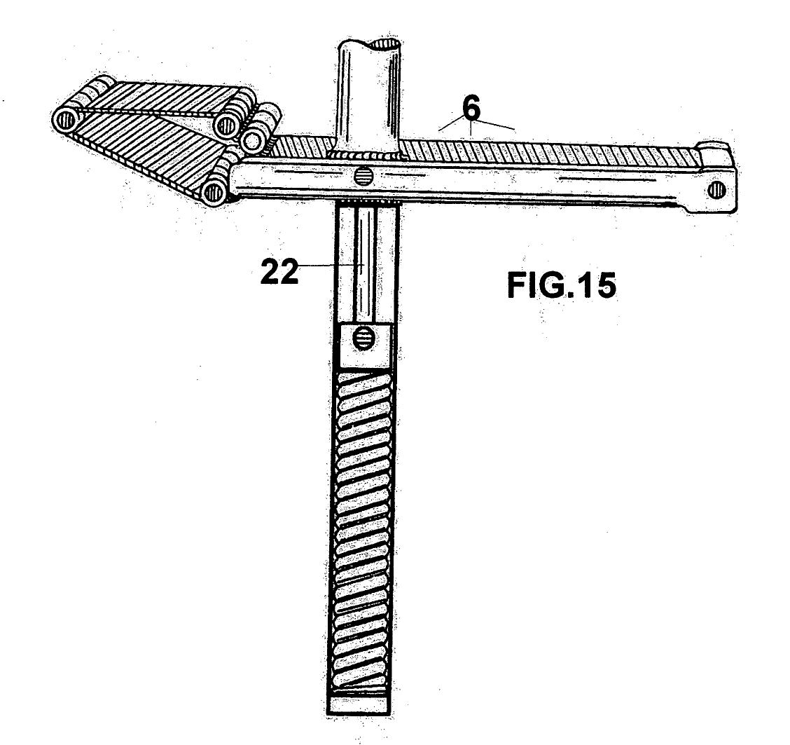

Referring to the drawings of FIG. 1 thru FIG. 15 illustrates the seat suspension suitable for use

On a bicycle as shown in items 1 thru 15. The illustrations are to provide a means of description and are not intended to limit the invention.

Further descriptions in FIG. 1 to one who has knowledge in such areas describes the seat suspension system 6, and to simplify its understanding, it is attached to a bicycle frame. Shown is the triple rear hinge 1, left side adjustable push rod 3A, right side adjustable push rod 3B, and central spring shock 2. The purpose of the adjustable push rods 3, 3A, 3B,are to provide a means of up and down adjustment for seat suspension 6 as would be encountered on a bicycle with the use of central spring shock 2.

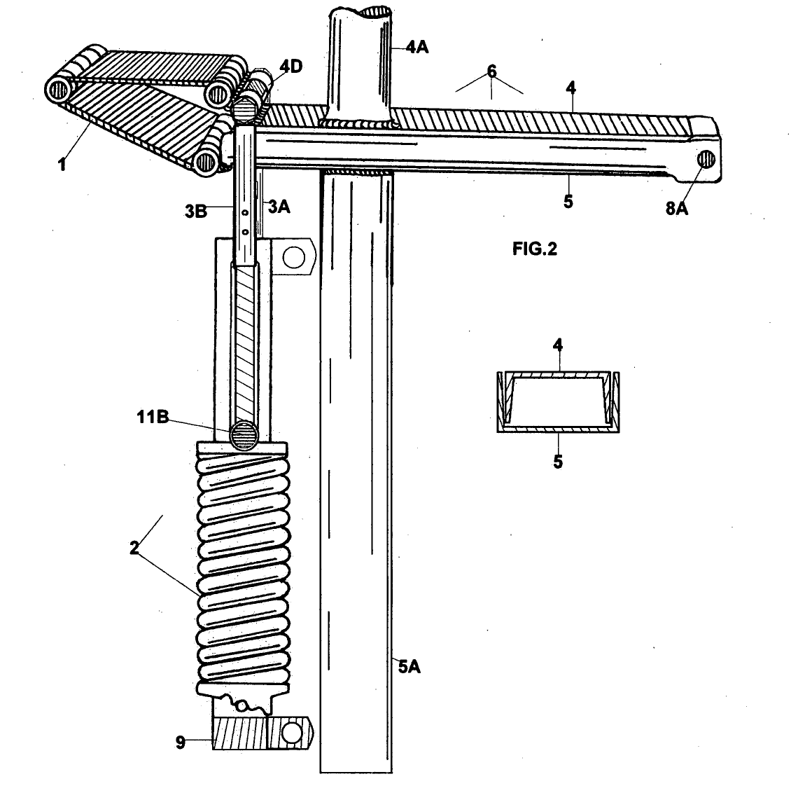

The Right side view seat suspension system 6 as viewed in FIG. 2 shows it in the down position or as would be encountered upon hitting a large bump it is fitted with a central spring shock 2 that is operated by means of two outer adjustable push rods left adjustable push rod 3A and right adjustable push rod 3B also a long pin 11B is used to attach the lower bushing of the dual push rods to the top of central spring shock 2, the upper bushing of the push rods are attached to rear split bushing 4D,with a standard nut and bolt the split bush 4D is secured to upper arm frame 4, by means of welding also shown is triple rear hinge l,which is also welded to upper arm frame 4 and lower arm frame 5, removable clamp 9, seat post tube for bicycle seat 4a, and post down tube 5a to fit inside a bicycle frame tube. Upper arm frame 4 and lower arm frame 5 (inset) are constructed of C channel one frame arm smaller in width so as to collapse inside the other so as to-provide a thinner profile and more travel.

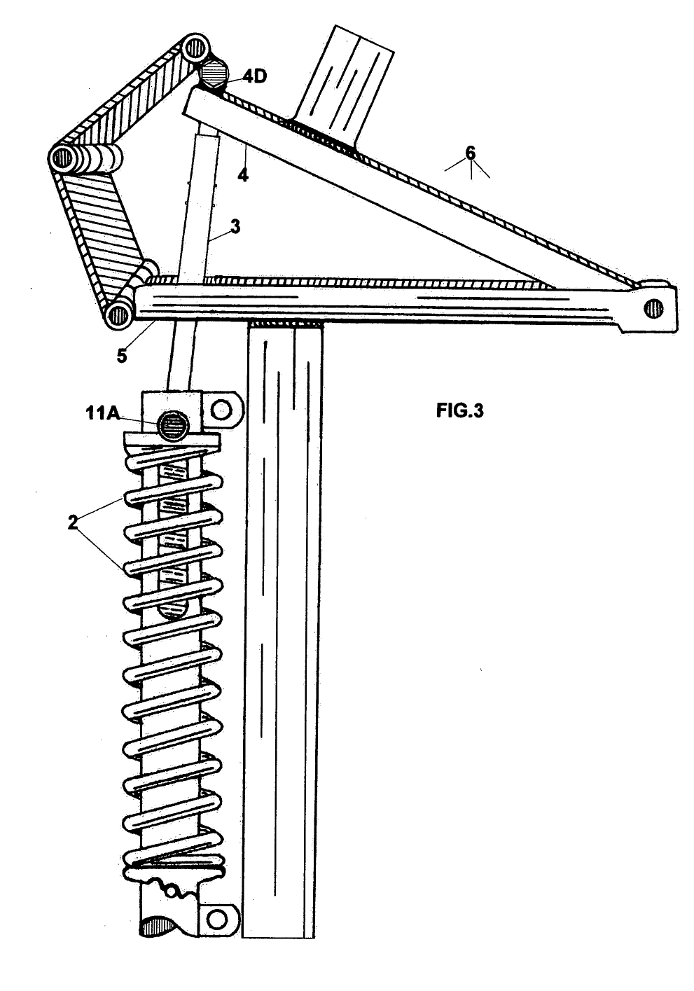

The seat suspension system 6, as viewed in FIG. 3 shows it in the up or normal position, it is fitted with a central spring shock 2, this view shows a single central adjustable push rod 3 which is fitted to middle split bushing 4D through a slot in upper frame 4 and a slot not shown in lower arm 5 and connected at the spring shock 2 with short pin 11A.

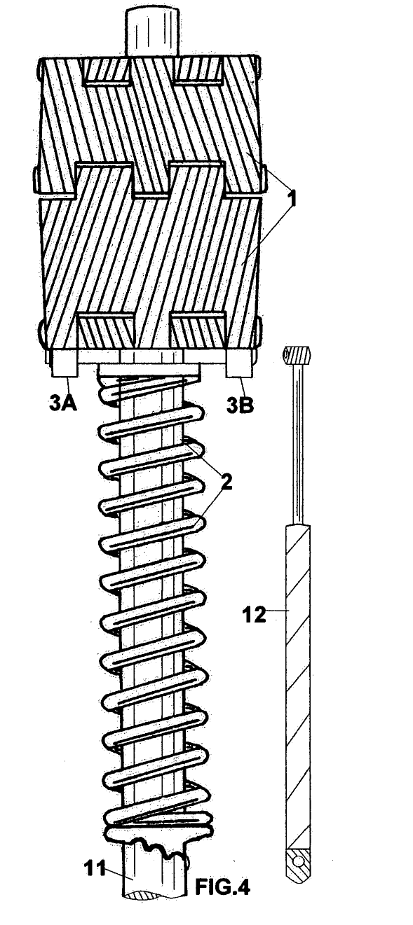

FIG. 4 shows a rear view of seat suspension with a centrally located spring shock 2, the rear triple hinge 1 fitted with dual adjustable push rods 3A, 3B, and an internally located gas spring or hydraulic shock absorber 12 which is fitted inside long spring shock tube 11.

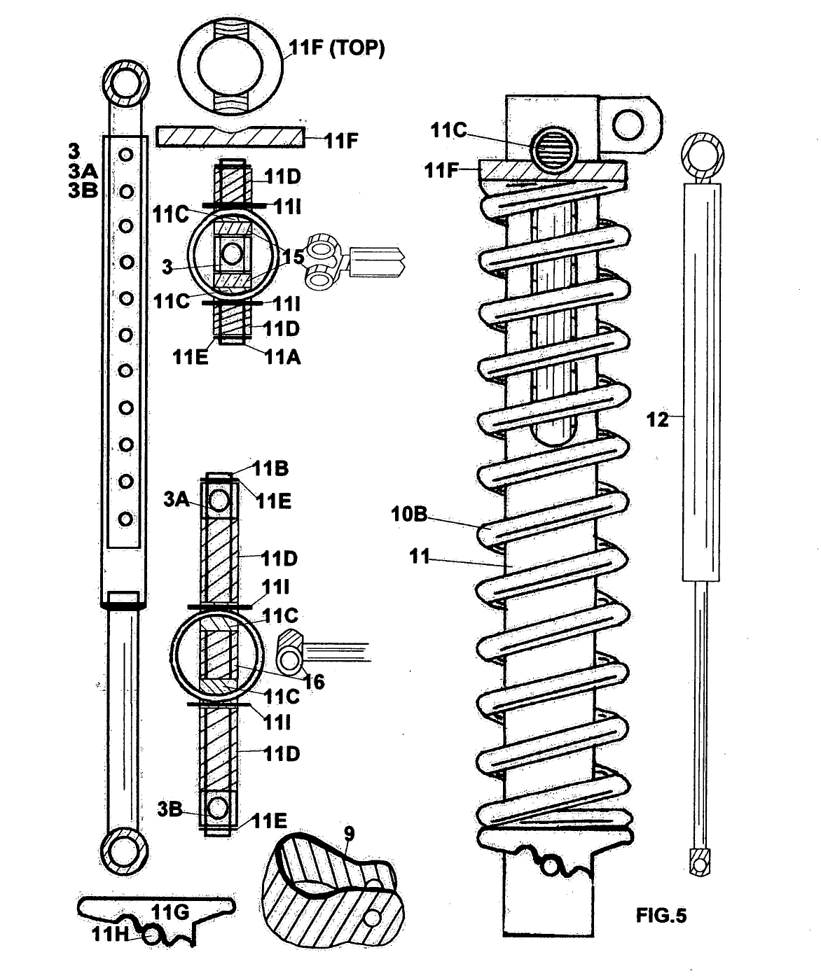

FIG. 5 is a view of centrally located spring over shock and associated parts. Shown is adjustable length push rods 3, 3A, 3B,used in both dual and single configurations, bottom collar and spring adjustment 11G and pin 11H for bottom collar and shock mount which is removable, clamp 9 which attaches the bottom of central spring shock assembly is also removable to facilitate spring removal. Top collar 11F as shown is machined to accommodate bushing 11C also shown are top views of pin assemblies long pin 11B for dual push rods 3A,3B, and 11A for single central push rod 3, also tubular spacers 11D can be of varied length to accommodate differences in pin length configurations bushings 11C are constructed to fit into the slot machined into spring shock tube 11 and let pins 11A,11B, rotate slightly, bearing washer 11I gives support for side to side movement. Also shown is spring shock assembly 11 and a gas or hydraulic type shock absorber 12 that fits inside spring shock tube 11 which can be of different load strength to accommodate various weights, the top of the internal shock 12 varies with push rod configuration yoke type bushing 15 for single central push rod and single bushing 16 for dual push rod configuration, clip 11E holds pin assembly.

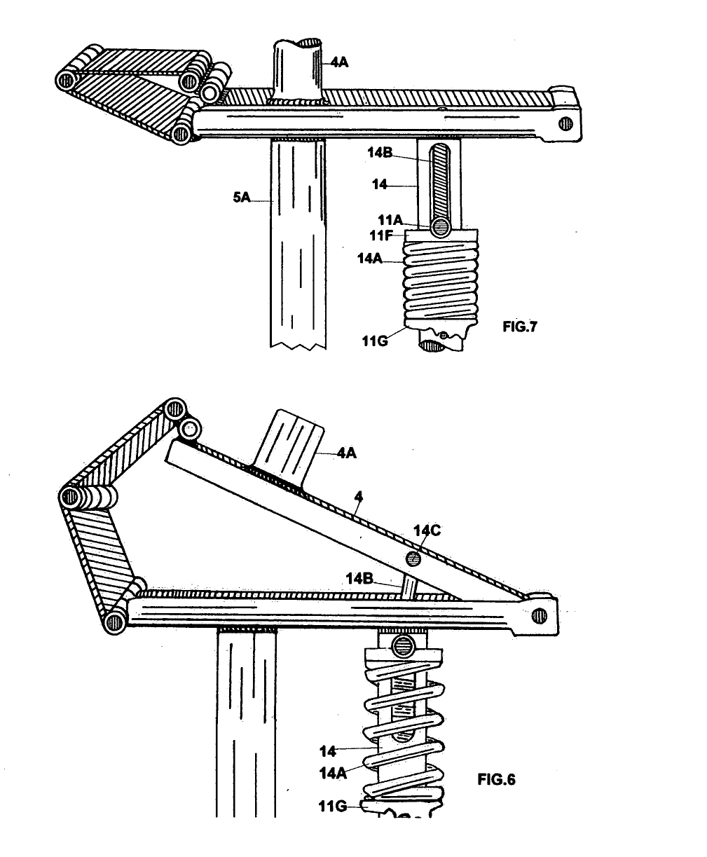

FIG. 6 shows the seat suspension fitted with front spring shock tube 14, short spring 14A, push rod 14B, pin 14C, split type bushing 4B,(not shown) located in under side of upper frame 4, all other parts are the same or similar to parts illustrated for central spring shock 2.illustrated in FIG. 5.

FIG. 7 shows seat suspension as in FIG. 6 but as would be compressed or upon encountering a bump.

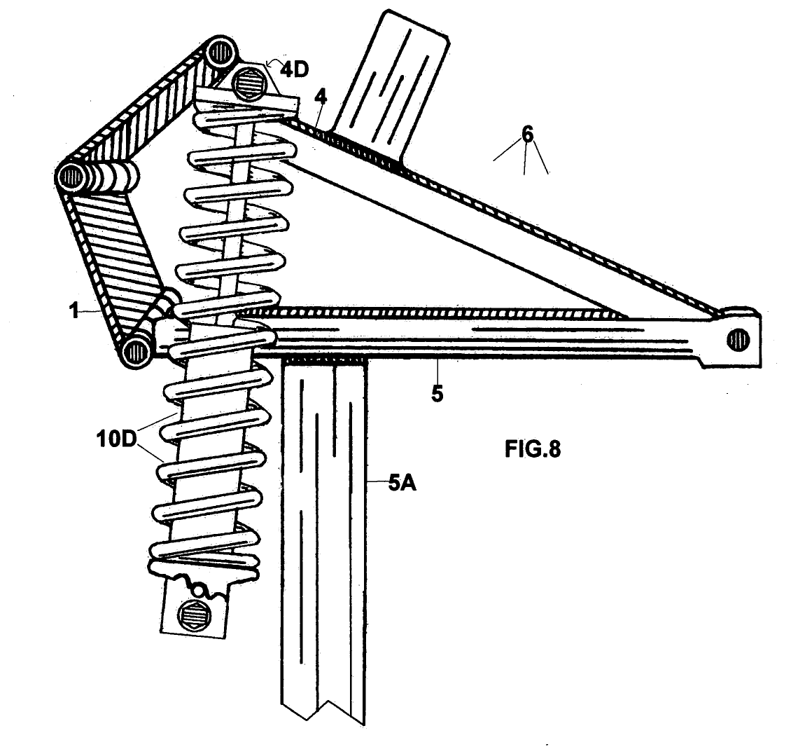

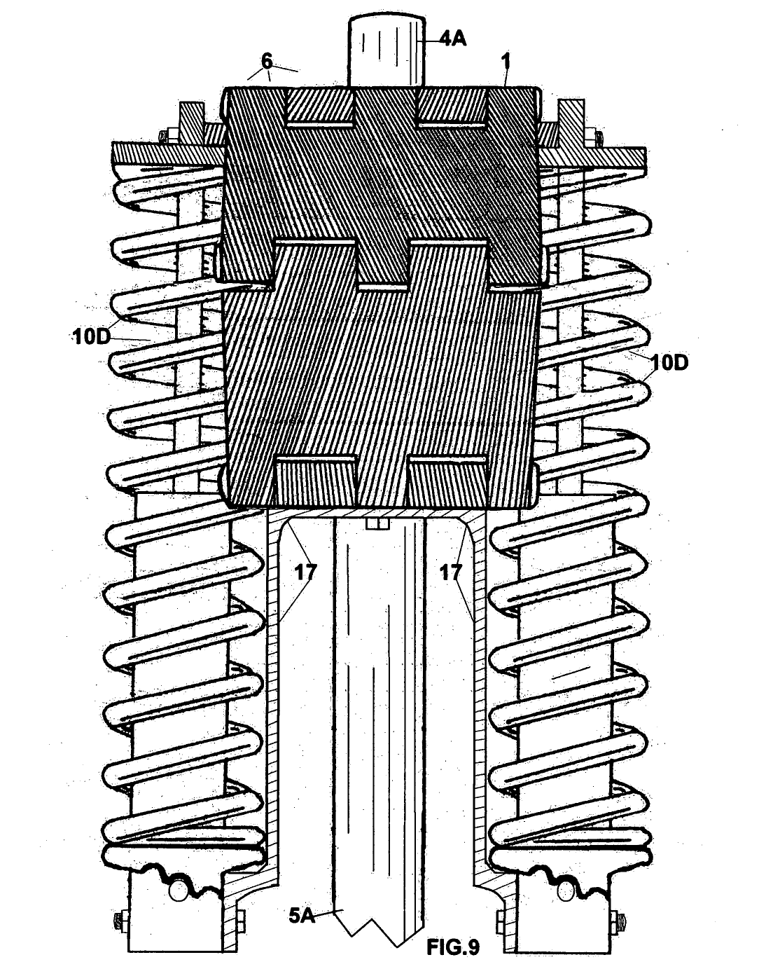

FIG. 8 is a right side view of the seat suspension 6 fitted with dual spring over shock absorbers 10D (Left side not shown) the top of which are mounted to the upper frame arm 4 by means of a standard bolt and nut to rear bushing 4D.

FIG. 9 is a rear view of seat suspension 6 equipped with dual spring over shock absorbers 10D, also shown is bottom spring over shock mount 17 which is bolted to lower frame arm 5 also shown is triple hinge 1.

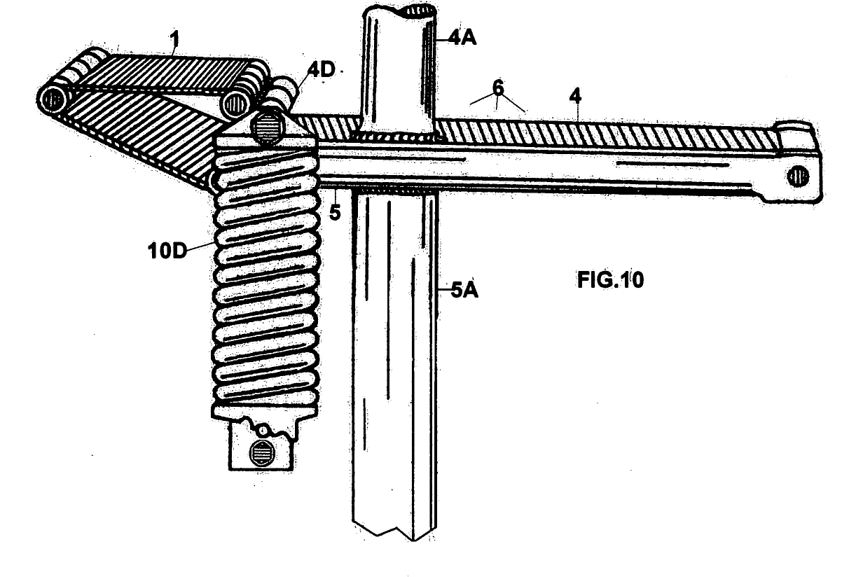

FIG. 10 is a right side view of seat suspension 6 fitted with dual spring over shock absorbers 10D as in FIG. 8 and FIG. 9 but shown in the down position.

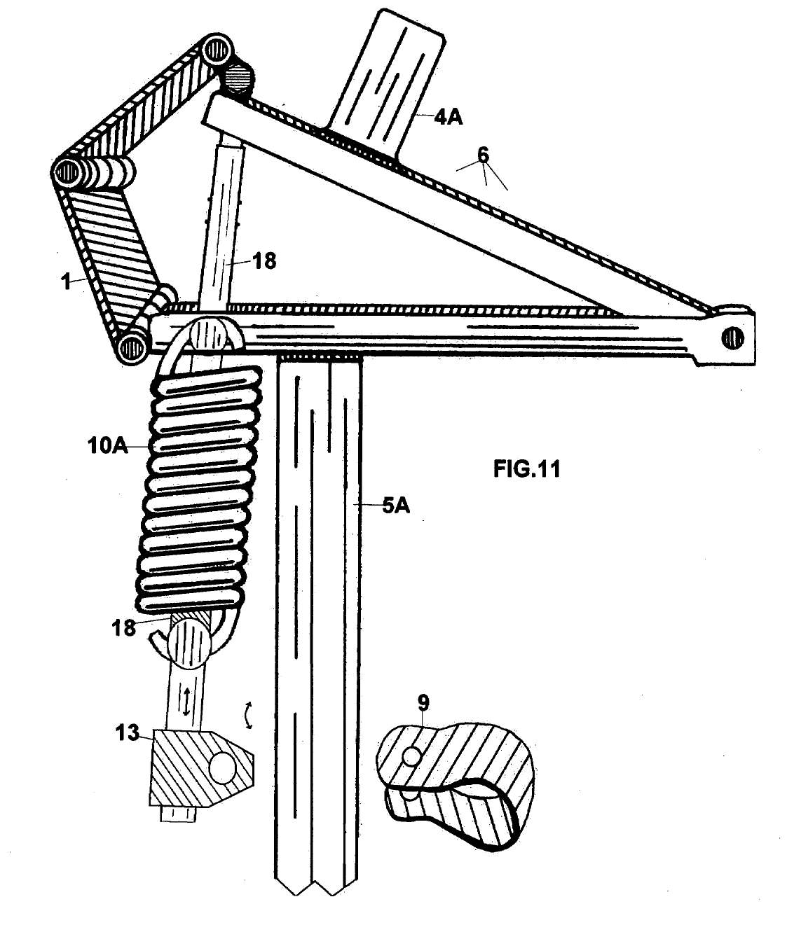

FIG. 11 is a right side view of seat suspension 6 in the up position fitted with dual extension type springs 10A (left spring not shown) also shown is adjustable push rod and lower spring mount 18 for fitting with different length Extension springs, slide swivel bushing 13, its purpose is to capture the lower portion of adjustable push rod and lower spring mount 18 and provide a controlled movement, clamp 9 purpose is to attach slide swivel bushing 13 by mean of nut and bolt (not shown) and loosely clamp to the down tube of a bicycle frame or similar arrangement and for the purpose of seat suspension 6 up and down movement to provide for taller riders and or different length springs, clamp 9 is moved up or down accordingly.

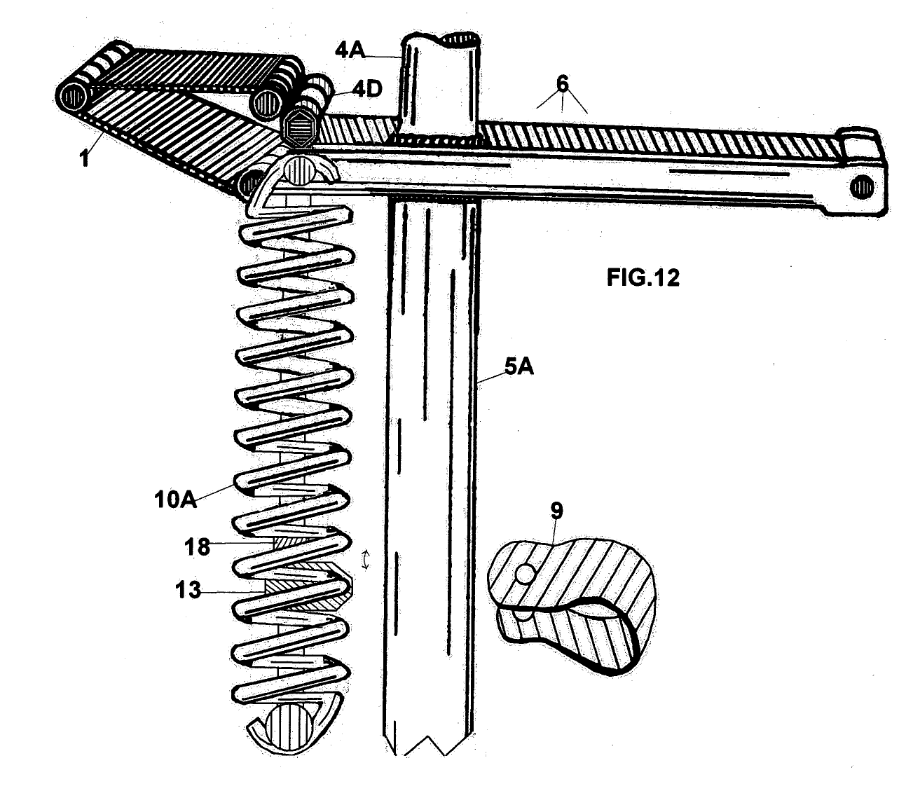

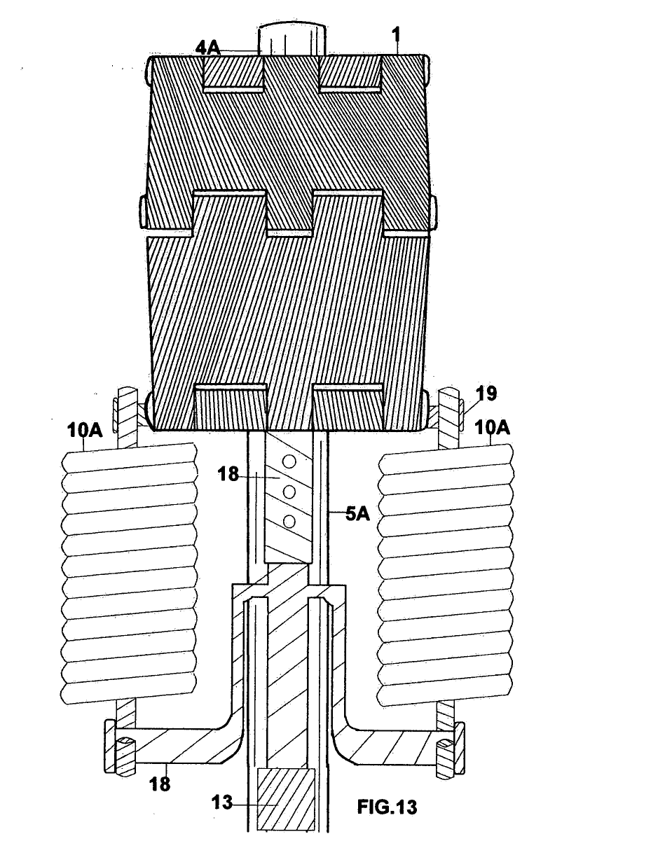

FIG. 12 is right side view of seat suspension 6 fitted with dual extension type springs 10A (left side not shown) as in FIG. 11, but situated in the down position as would be encountered hitting a bump, the slide swivel bushing 13 allows the lower portion of adjustable push rod 18 to slide and swivel in accordance with seat suspension 6 movement.

FIG. 13 is a rear view of seat suspension 6 shown is post for bicycle type seat 4A, triple hinge 1, bicycle type down post tube 5A, extension spring 10A, upper mount pin 19, which is attached to lower arm frame 5, (not visible in FIG. 13). Adjustable push rod and extension spring lower mount 18,its purpose is to transfer the weight of the person to the lower part of the extension spring and is adjustable to provide for different length springs and variation in frame configurations, also shown is slide swivel bushing 13.

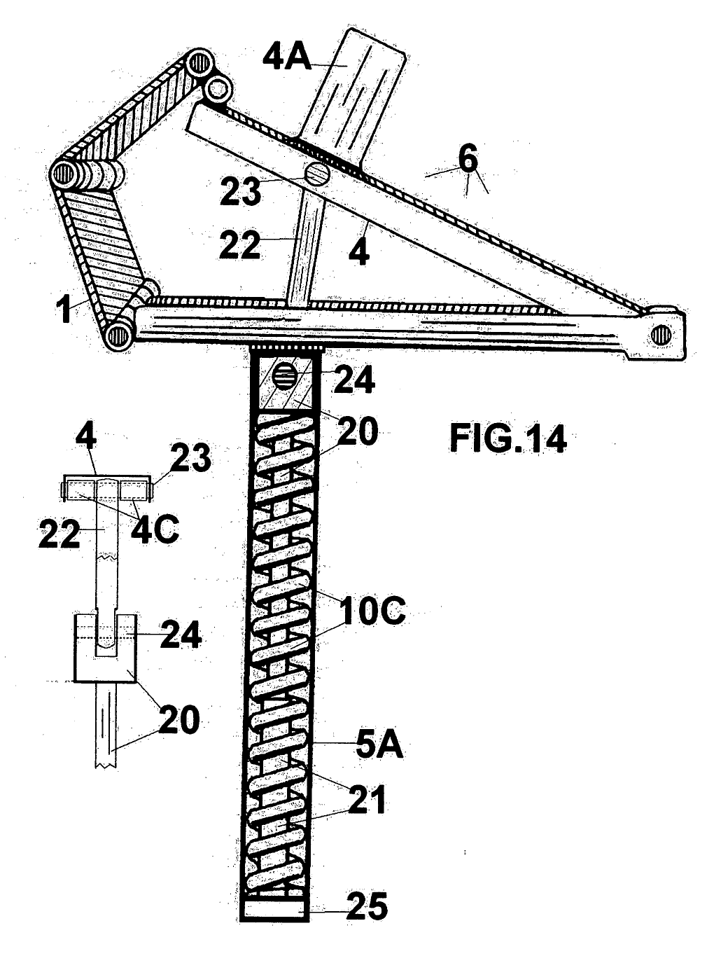

FIG. 14 shows a right side view of seat suspension 6 fitted with A Compression Spring 10C inside down tube 5A, its diameter and rate in proportion to the amount of load incurred also shown are Push Rod 22, upper pin 23, and Middle Split Bushing 4C (inset) also Piston Plunger and Guide Rod 20, push rod to piston Pin 24, Guide Tube 21, and Spring Stop 25.

FIG. 15 show a right side view of seat suspension 6 as in FIG. 14 but in the compressed position also illustrated is angle of push rod 22 upon compression.

What is claimed is:

1. A bicycle seat suspension suitable for use on other type vehicle apparatus comprising:
A lower arm frame and an upper arm frame constructed of strong material preferably a metal channel with one arm frame being of lesser width so as to fit inside the other when collapsed,
The front of said lower arm frame and front of said upper arm frame are joined by a hinge;
The rear of the lower arm frame and the rear of the upper arm frame are joined together by means of a triple hinge, the leaf portion of said triple hinge directly attached to the lower and upper arm frames is of very short length its width pin to pin approximately one third the length of the lower arm frame and hinge length approximately three inches or of sufficient length to provide sufficient lateral stability;
The said triple hinge which is attached to the rear of said lower arm frame, and the rear of said upper arm frame, whereas the leaf attachment to the said upper arm frame is raised slightly approximately one half inch and forward approximately five sixteenth inch, as would be compared to the leaf attachment of the lower arm frame when the seat suspension is collapsed and compared in a central plain with respect to the said front hinge so as to facilitate that the middle knuckle of the rear triple hinge will be in a raised position as compared to a central plain compared to the front hinge when suspension is in the collapsed or down position;

2. The seat suspension as in claim 1, wherein with attachment of a bicycle seat post tube to the upper arm frame approximately three quarters the length towards the rear of the upper arm frame and a bicycle type down post frame mount tube attached approximately three quarters the length towards the rear of the lower arm frame.

3. A seat suspension as in claim 1 or 2, further comprising the addition of a centrally located spring so as to provide suspension;
A tube with a slot machined in the sides of the tube so as to insert a pin with bushings and spacers, the said pin connected to an adjustable push rod that is centrally located;
The said adjustable push rod is constructed of two pieces, a rod inside a tube with the means of being adjustable in length for the purpose of being able to raising or lower the seat suspension and provide a means of attaching the weight carrying upper arm frame and attachment to the stationary spring and shock tube;
The lower part of said slotted tube provides a removable pin which attaches the bottom spring collar and adjustment, a removable clamp provides a lower mounting point;
The upper portion of adjustable push rod is attached to upper arm frame by means of a split bushing and bolt. The lower portion of the adjustable push rod attaches to said pin which fits inside slot of slotted tube;
The said slotted tube is fitted with a removable internal shock absorber connected at its top with a yoke type fitting and at its bottom by lower removable pin.

4. A seat suspension as in claim 1 or 2, further comprising the addition of a centrally located spring so as to provide suspension;
A tube with a slot machined in the sides of the tube so as to insert a pin with bushings and spacers, the said pin connected to dual adjustable push rods located on each side of said tube
The said adjustable push rods are constructed of two pieces, a rod inside a tube with the means of being adjustable in length for the purpose of being able to raising or lower the seat suspension and provide a means of attaching the weight carrying upper arm frame and attachment to the stationary spring and tube;
The lower part of said slotted tube provides a removable pin which attaches the bottom spring collar and adjustment, a removable clamp provides a lower mounting point;
The upper portion of adjustable push rods are attached to upper arm frame by means of a bushings and bolt. The lower portion of the adjustable push rods are attached to said pin which fits inside slot of slotted tube;
The said slotted tube is fitted with a removable internal shock absorber connected at its top with a bushing type fitting and at its bottom by lower removable pin.

5. A seat suspension as in claim 1 or 2, with the addition of a short front mounted die type spring with a short centrally mounted push rod, a short slotted tube securely mounted to the Under side of lower arm frame and with bushings and top and bottom spring collar and pins.

6. A seat suspension as in claim 1 or 2, further comprising the addition of dual, spring over shock type absorbers for the purpose of suspension;
The tops of said spring over shock absorbers are mounted to the rear portion of upper arm frame by means of bolts and the lower portion of said spring over shock type absorbers bolt to a mounting plate which is securely attached to the lower arm frame.

7. A seat suspension as in claim 1 or 2, further comprising the addition of dual, extension type springs for the purpose of suspension;
The top hooks of said extension springs are mounted to the rear portion of the lower arm frame, and the lower hooks of said extension springs mount to a centrally located push rod;
The said push rod, top mounts to the rear portion of the upper arm frame by means of a slotted bushing and bolt pin, slots machined into lower and upper arm frames provide clearance for its central location and the arcing movement of the said push rod upon up and down movement, the said push rod is adjustable in length to provide for different length extension type springs;
On the lower most part of said push rod, is a slide swivel bushing which provides stability and captures the push rods lower portion and allows for a predictable sliding and swivel movement of the said push rod;
The said slide swivel bushing is mounted via a moveable clamp so as to provide an up and down adjustment of said seat suspension;
To accommodate a shorter length push rod the lower spring hooks mounting pin is made in a inverted u shape and firmly attached to the lower portion of the said adjustable push rod so as to allow an up and down movement of the push rod and not collide with the slide swivel bushing.

8. A seat suspension as in claim 1 or 2, with the addition of a centrally located spring mounted inside A bicycle type down tube so as to be able to move the seat suspension in an up and down position and to provide suspension;
The spring is actuated by a piston slotted at the top and pinned to accommodate a push rod which is attached to the upper arm flame by means of a pin and bushing, the slotted piston allows for an arcing movement of the push rod upon movement of the seat suspension to the middle underside of the slotted piston is fitted a piston plunger guide rod Which fits inside a guide rod tube bushing located at the lower portion of the said bicycle type down post tube so as to provide a guide path for said slotted piston;
